(19) United States
(12) Patent Application Publication
(10) Pub. No.: US 2002/0010595 A1
(43) Pub. Date: Jan. 24, 2002

(54) Web-based medication management system

(76) Inventor: Thomas L. Kapp, Katy, TX (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 09/825,141

(22) Filed: Apr. 2, 2001

Related U.S. Application Data
(63) Continuation-in-part of application No. 09/032,512, filed on Feb. 27, 1998, now abandoned.
(60) Provisional application No. 60/193,636, filed on Mar. 31, 2000.

(51) Int. Cl. G06F 17/60

(52) U.S. Cl. 705/2

(57) ABSTRACT

A drug database system that is particularly adapted for drug prescribing and drug dispensing activities is disclosed. In accordance with one aspect of the present invention, information on the usage, dosing and contraindications for a plurality of drugs is provided via a communications link to persons desiring such information. All information is provided in response to a request that includes specific information. The information provided can be of different types and varies with the information in the request. The information provided may be provided to the person making the request or to another person associated with the person making the request. Advantageously, the system provides real-time access to a plurality of persons requesting drug information. In addition, the drug information stored in the system may be dynamically modified. Such modifications is provided by permitting selective access to the database by drug manufacturers, drug researchers and the like. Accordingly, the most up-to-date information on a drug is provided.

This application claims priority to U.S. Provisional Application Serial No. 60/193,636, entitled “Web-Based Medication Management System,” filed Mar. 31, 2000 and U.S. patent application Ser. No. 09/032,512, entitled “Pharmacy Drug Management System Providing Patient Specific Drug Dosing, Drug Interaction Analysis, Order Generation, and Patient Data Matching,” filed Feb. 27, 1998, which are incorporated herein by reference.

### FIELD OF THE INVENTION

The present invention relates to a web-based medication management system for monitoring and recording drug prescribing and dispensing activities. More particularly, the present invention provides a system and method for multiple users to access and interact in real time, a medication management system regarding patient specific drug, dosing interaction analysis and order generation.

### BACKGROUND OF THE INVENTION

Iatrogenic illnesses (illnesses caused by the medical profession) have been a significant cause of disease and death of patients. Most iatrogenic illnesses result from complications of drug therapy. Adverse drug reactions have been the cause of roughly 10% of all hospital admissions and are believed to be the fourth highest cause of death in the United States. Thirty six percent or more of hospitalized patients have their problems compounded by suffering iatrogenic drug effects. Many ambulatory patients, especially those on numerous medications and suffering a variety of ailments, are also candidates for iatrogenic drug problems. Further, it is believed that iatrogenic drug illnesses cost the American economy many billions of dollars a year.

National statistics from the insurance industry estimate that 28% of all medical malpractice suits are the results of improper use of medications. It is widely thought that medical malpractice suits for adverse drug reactions will increase five fold over the next few years as lawyers and patients become more sophisticated as to their understanding of iatrogenic drug problems and their complexities. In many cases where there are no errors in clinical procedure or judgment, many will try to distort the relevant facts. The latter scenarios are predicated on the assumptions that physicians will not specifically address the issue, continue to practice as before, and hope that all potential problems never materialize.

Within a hospital, numerous orders for drugs causing adverse drug reactions for patients are written a day. Preparing and processing an order begins with a doctor physically writing an order. The order is then entered by a nurse into a computer connected to a pharmacy database so that the order may be processed. While the order is being processed, the doctor depending on the time of day is busy with other patients or has left the hospital. The order may then come up on the screen of the computer indicating there is a drug interaction problem. The ordered drug may have a problem interacting with another drug prescribed for the patient. The ordered drug might also negatively impact the patient's medical condition.

Drug interaction information for certain drugs is stored in the pharmacy database. If either type of problem is detected by the computer system, then a message pops up on the screen of the computer system indicating a drug interaction problem. The doctor is then called or paged and requested to prepare a new order. Meanwhile, the patient who is in need of immediate drug therapy must wait for the doctor to write a new order. If the drug selected for the new order also causes a drug interaction problem detected by the computer system, then filling the order is again delayed. The conventional system for preparing and processing an order thus not only creates an order without taking patient-specific data into account (particularly since an order is physically written) but also checks for drug interaction problems after an order has already been written.

Adverse drug reactions are particularly significant in geriatric pharmacology. Elderly persons often have multiple chronic diseases and are under multiple medications, increasing concern regarding drug-drug (or drug to drug) and drug-disease interactions. Many common symptoms of the elderly (e.g., gastrointestinal problems, dizziness, and mental status changes) can be difficult to distinguish from drug side effects or may be caused and exacerbated by medications. Introduction of a new medication into the regime of an elderly individual is thus fraught with adverse possibilities.

In an age where economic concerns have moved to the forefront of health care, adverse drug effects are becoming increasingly important. In many cases, drugs that are less costly to purchase result in significantly greater overall cost to the patient and the health care system because of adverse drug events. Such events can result in emergency room visits, extra doctor visits and even additional prescriptions, hospitalizations, and other tests or procedures. Yet, reporting of adverse drug effects by practitioners has mostly been ad hoc, typically through voluntary reporting programs or underutilized adverse event reporting procedures such as that of the Food and Drug Administration.

Overdosing and underdosing of drugs has also contributed to numerous iatrogenic illnesses. For certain classes of drugs such as aminoglycosides and cephalosporins, precise therapeutic dosing levels must be determined. The goal of the medical profession has been to avoid overdosing and underdosing by tailoring drug administration to an individual patient's needs. In pursuit of this goal, the medical profession has predominately utilized pharmacokinetic principles in drug dosing. The basic pharmacokinetic parameters, which include volume of distribution, rate of metabolizing, rate of excretion, rate of absorption and half-life, are commonly used in equations for calculating dosing amounts and the dosing integral for drugs requiring precise therapeutic dosing levels. However, so far as is known, the medical profession has lacked a capability of automatically identifying a drug needing precise therapeutic dosing and then quickly utilizing pharmacokinetic principles and patient-specific data to dose a patient for the drug.

The administration of drug therapy has required clinical professionals to use numerous distinct and dispersed tools and resources, such as a formulary listing available drugs, an infusion calculator, a pharmacy database, patient records, clinical reports, and drug-specific advisories. For the medical profession, some inconvenience is necessarily suffered due to reliance upon these different tools which are often not readily accessible. The time a clinical professional needs to determine drug therapy for a patient is a significant factor for patients in need of immediate therapy. The significant time required by clinical professionals to locate and consult various resources has thus prolonged the waiting period for patients.

In spite of the recent advances, including computer software package and its various modifications, there exists a need for a system and process where multiple users can access current information regarding patient specific drug, dosing interaction analysis and order generation. The methods should allow multiple users to interact in real time via the internet, as well as update drug and patient information. Preferably, the overall methodologies will be capable of rendering access in real time to physicians, pharmacists, drug companies, third-party payers and patients. For example, a pharmacist and drug company can interact in real time regarding adverse drug effects and make updates immediately without the need to generate or wait for a new CD comprising new and current information regarding patient specific drug, dosing interaction analysis and order generation The present invention fulfills these and other needs.

### SUMMARY OF THE INVENTION

The present invention provides a medication management system that is particularly adapted for drug prescribing and drug dispensing activities. As used herein, the term “drug” means any material regardless of form, i.e., pill, tablet, capsule, lotion, liquid or ointment, that is taken for health or medicinal purposes with or without a physician's authorization. That is, the term drug includes both prescription and over the counter drugs.

In accordance with one aspect of the present invention, information on the usage, dosing and contra-indications for a plurality of drugs is provided and stored in a database that is accessible, via communication links, to at least one individual desiring drug information. Such individuals, include but are not limited to, doctors, nurses, pharmacists, prospective drug users, who desire up-to-date drug information. In accordance with another aspect of the present invention, the information stored in the database is not static, i.e., a snapshot in time, but is dynamic. That is, the drug information stored in the database can be changed through additions, deletions and modifications by at least one drug information provider. Such provider may include any individual with useful information about a drug, e.g., drug manufacturers, drug researchers, etc. To maintain the integrity of the database, those individuals given the ability to add, delete or modify stored drug information may be controlled. Advantageously, the interaction between a person desiring drug information and/or a person providing drug information may occur in real-time. As a result, the information provided by the system is the latest available on any particular drug and an individual desiring such information can quickly obtain the same when such desire arises.

Advantageously, individuals desiring drug information can obtain the same via a variety of input modes. In one mode, the name of a drug can be provided and the system will output the drug usage, dosage and/or contraindications. In another mode, the malady or symptom to be treated is entered and the system will provide suitable drugs for such malady or symptom. Ancillary data, such as the patient's age, sex, allergies, etc. can be provided or requested by the system to select an appropriate drug for the patient using the ancillary data as well as the symptom or malady. In other modes, the patient may be already taking certain drugs for preexisting conditions and such information is provided along with the new malady or condition for which drug treatment is desired. In such case, the system advantageously uses such information to select the most appropriate drug to treat the new malady or condition to reduce the likelihood of known adverse drug interactions.

### BRIEF DESCRIPTION OF THE DRAWINGS

A better understanding of the present invention can be obtained when the following detailed description of the preferred embodiment is considered in conjunction with the following drawings, in which:

FIG. 1 is a schematic block diagram of an exemplary medication management system in accordance with the present invention;

FIG. 2 is a schematic diagram illustrating the medication management system of FIG. 1 in a web-based environment;

FIG. 3 is a schematic block diagram of a pharmaceutical management care system module of the medication management system of FIGS. 1 and 2;

FIG. 4 is a block diagram of exemplary main web pages for the medication management system of FIGS. 1 and 2;

FIGS. 5A and 5B are screen shots of exemplary “Patient Record” web pages for the medication management system of FIGS. 1 and 2;

FIG. 6 is a screen shot of an exemplary “Modify Patent Record” web page for the medication management system of FIGS. 1 and 2;

FIG. 7 is a screen shot of an exemplary “Drug Allergy Pick List” web page for the medication management system of FIGS. 1 and 2;

FIG. 8 is a screen shot of an upper portion of an exemplary patient profile web page for the medication management system of FIGS. 1 and 2;

FIG. 9 is a screen shot of a lower portion of the exemplary patient profile web page for the medication management system of FIGS. 1 and 2;

FIG. 10 is a screen shot of an exemplary “Diagnoses” web page for the medication management system of FIGS. 1 and 2;

FIG. 11 is a screen shot of an exemplary “Add Diagnoses” web page for the medication management system of FIGS. 1 and 2;

FIG. 12 is a screen shot of an exemplary “Medications” or RxWorkSheet web page for the medication management system of FIGS. 1 and 2;

FIG. 13 is a screen shot of an exemplary medication selection web page for the medication management system of FIGS. 1 and 2;

FIG. 14 is a screen shot of an exemplary “Medication Advisories” web page for the medication management system of FIGS. 1 and 2;

FIG. 15 is a screen shot of an exemplary medication order web page to select the strength and form of a medication for an on-screen medication order for the medication management system of FIGS. 1 and 2;

FIG. 16 is a screen shot of an exemplary medication order web page showing an onscreen medication order for the medication management system of FIGS. 1 and 2;

FIG. 17 is a screen shot of an exemplary “Adverse Drug Events” web page for the medication management system of FIGS. 1 and 2;

FIG. 18 is a screen shot an exemplary adverse drug event report web page for the medication management system of FIGS. 1 and 2;

FIG. 19 is a screen shot an exemplary adverse drug event report web page continued from the web page of FIG. 18;

FIG. 20 is a screen shot of an exemplary label from an on-screen medication order for the medication management system of FIGS. 1 and 2;

FIG. 21 is a screen shot of an upper portion of an exemplary drug interaction web page for the medication management system of FIGS. 1 and 2; and

FIG. 22 is a screen shot of a lower portion of the exemplary drug interaction web page for the medication management system of FIGS. 1 and 2.

### DETAILED DESCRIPTION OF PREFERRED EMBODIMENT

A drug database system that is particularly adapted for drug prescribing and drug dispensing activities is disclosed. In accordance with one aspect of the present invention, information on the usage, dosing and contraindications for a plurality of drugs is provided via a communications link to persons desiring such information. All information is provided in response to a request that includes specific information. The information provided can be of different types and varies with the information in the request. The information provided may be provided to the person making the request or to another person associated with the person making the request. Advantageously, the system provides real-time access to a plurality of persons requesting drug information. In addition, the drug information stored in the system may be dynamically modified. Such modifications is provided by permitting selective access to the database by drug manufacturers, drug researchers and the like. Accordingly, the most up-to-date information on a drug is provided.

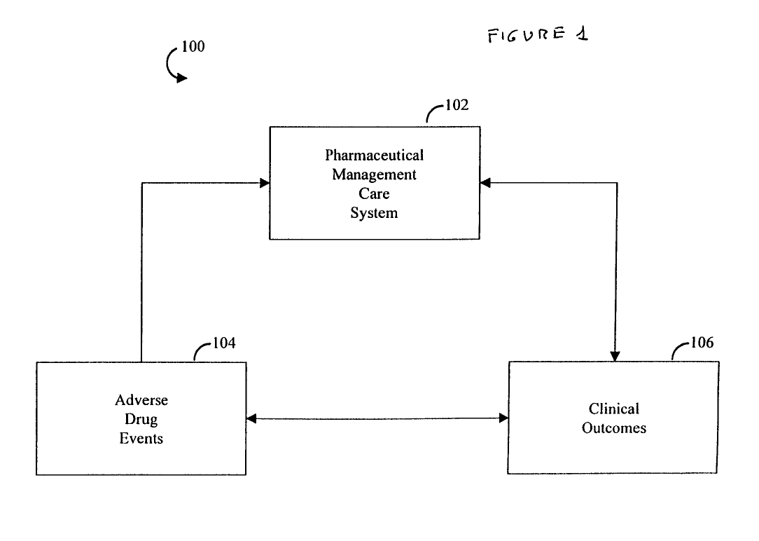

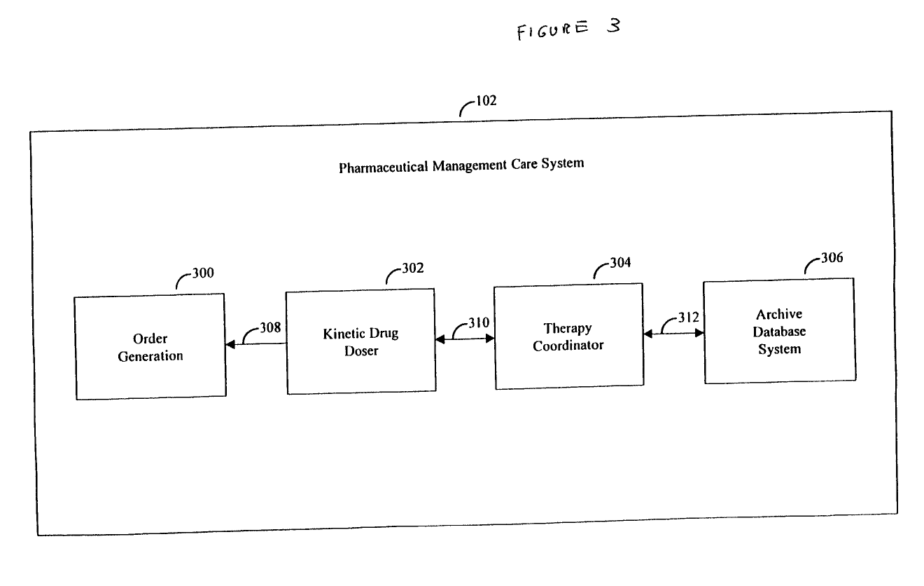

Turning now to the drawings, FIG. 1 is a block diagram representing an exemplary logical organization of medication or disease management system software 100. The medication management system 100 logically includes a pharmaceutical management care system module 102, a clinical outcomes module 106 and an adverse drug events module 104. The pharmaceutical management care system module 102 enables a physician to control patient-specific drug dosing, perform drug interaction analysis, generate an on-screen medication order or perform patient data matching. This module 102 is described in more detail in connection with FIG. 3 and in U.S. patent application Ser. No. 09/032,512, entitled “Pharmacy Drug Management System Providing Patient Specific Drug Dosing, Drug Interaction Analysis, Order Generation, and Patient Data Matching,” to Applicant, previously incorporated herein. The clinical outcomes module 106 represents the generation and use of clinical outcomes by the pharmaceutical management care system module 102. A clinical outcome is essentially any information relevant to management of drug therapy for a patient. Examples of clinical outcomes include the date a patient starts a drug, the date the patient ends the drug, the effect of the drug on the patient and the effect of the drug on the disease or medical condition of the patient. In other words, a clinical outcome is also any information relevant to how the disease or medical condition of the patient is being managed.

The adverse drug events module 104 represents a way of recording a specific type of clinical outcome, an adverse drug event. An adverse drug event is essentially any information as to an adverse event resulting from the drug therapy of a patient. As described in more detail below, a physician can easily record adverse drug events of a patient with an “Adverse Drug Events” web page of the medication management system 100. Both clinical outcomes and adverse drug events are generated by or available to the pharmaceutical management care system module 102. It should be understood that the term “module” is not used in a strict sense, since the medication management system 100 can be implemented in software in a variety of ways other than the illustrated exemplary organization.

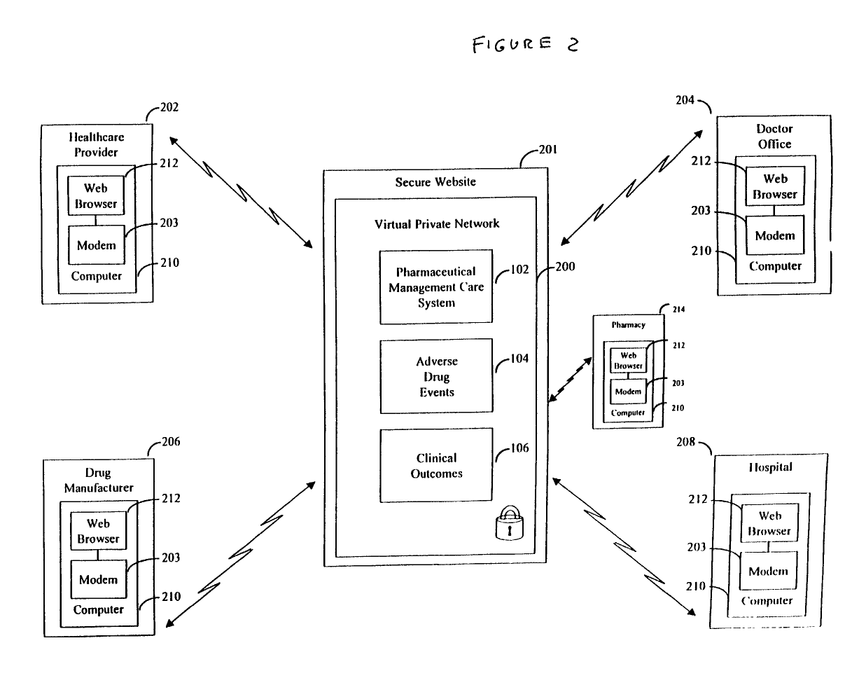

Referring to FIG. 2, the medication management system 100 is shown in a web-based environment. The medication management system 100 resides on a secure web site 201 using software or hardware implemented security procedures and protocols for maintaining a virtual private network 200. In this way, any physician or other user can securely and remotely access the medication management system 100 and confidentiality of patient and practice data is maintained. A virtual private network (VPN) is understood to be a wide area communicating network provided by a common carrier and is configured within a public network. A web site is understood to be a web server on the Internet that contains World Wide Web documents. The World Wide Web is understood to be an Internet service that links information and software by providing hypertext links from server to server. Hypertext Transfer Protocol (HTTP) is the protocol currently used for sending web page information. The illustrated example shows that the medication management system 100 can easily be accessed from a doctor's office 204, a hospital 208, a drug manufacturer 206 or a healthcare provider 202, for example. Each of these locations includes a computer system 210 with a modem 203 coupled to a web browser 212 for a user to interact with the medication management system 100. A web browser is understood to be a program used to view information on the World Wide Web. The web browser 212 interprets or translates a web page information commonly in the form of HTML (hypertext markup language) code from the web site 201 to produce a web page on a display screen of the computer system 210. To access the medication management system 100, the physician directs the web browser 212 to submit a unique web address (a uniform resource locator) to the web site 201 on which the medication management system 100 resides. In response, the web site 201 fetches a web page corresponding to the web address and sends the web page to the web browser 212. A private tunnel connection is maintained between the web browser 212 and the web site 201. The data passed between the web browser 212 and the web site 201 can be protected using industry-standard encryption. A proper user identifier and password must be verified before a user can access the web site 201. Other ways of recognizing or identifying the user over the Internet, such as through digital certificates, may be employed in addition or alternatively.

For sake of simplicity, certain conventional components of a computer system are not shown. For example, the computer system 210 of course includes a processor, an operating system, and a display screen. As an alternative to a computer system, a user may employ other computing systems with modem and web browsing capabilities to access the medication management system 100, such as personal digital assistants (e.g., Palm organizers), cellular phones, or Internet appliances for example. In addition, a variety of computer systems, including, but not limited to, desktop computers, laptop computers, handheld computers and network servers can be used to securely access the medication management system 100. In other words, the medication management system 100 can be accessed from a variety of hardware platforms.

The locations shown in FIG. 2 from which one may access the medication management system 100 are only illustrative, as the medication management system 100 can be utilized by a variety of users and can essentially be accessed securely from anywhere in the world. The medication management system 100 can be easily accessed from wherever physicians are located. Should the Internet connection go down or crash, a physician then uses a CD-ROM, DVD-ROM or other version of the medication management system 100 on the computer system 210 of the physician. When the Internet is back up, the remote version of the medication management system 100 on the web site 201 is updated with information from the local version of the medication management system 100 on the computer system 210 of the physician. Another example of a location from where the medication management system 100 can be accessed is a pharmacy 214. A pharmacist can receive and fill an on-screen medication order generated by the medication management system 100. The medication management system 100 can even be accessed by a user from a health maintenance organization (HMO) or a doctor's clinic. Further, the medication management system 100 may be securely maintained on a web site in ways other than in connection with a virtual private network.

Referring to FIG. 3, a block diagram of the pharmaceutical management care system module 102 is shown. The module 102 includes an order generation submodule 300, a kinetic drug doser submodule 302, a therapy coordinator submodule 304 and an archive database system submodule 306. As represented by an arrowed line 308, a drug dosed for a patient by the kinetic drug doser module 302 may be entered into an on-screen medication order using the order generation module 300. As represented by an arrowed line 310, the therapy coordinator module 304 provides patient data accessible to the kinetic drug doser module 302 and the kinetic drug doser module 302 provides drug dosing data accessible to the therapy coordinator module 304. The kinetic drug doser module 302 may include multiple drug dosers where each drug doser is directed to a different category of drugs. For example, the kinetic drug doser module 302 can include a narcotics doser for dosing narcotics or a chemodoser for dosing drugs for oncology patients. As represented by arrowed line 312, drug therapy data for other patients stored by the archive database system module 306 is accessible to the therapy coordinator module 304 and drug therapy data for a patient can be provided from the therapy coordinator module 304 to the archive database system 306 to update the database. Since the pharmaceutical management care system module 102 is part of the medication management system 100 on the web site 201, the module 102 can be utilized over the Internet by physicians. By securely and reliably providing the module 102 over the Internet, the pharmaceutical management care system software is easily available to the global medical/pharmacy community.

The archive database system submodule 306 enables a user to conveniently access a patient data matching database for matching patients to specific drug therapies of other patients in the same disease or medical condition class. Through a questionnaire, answers are entered relating to the patient. The database is then searched for “similar” patients matching the entered parameters. One parameter, for example, can be the disease or medical condition class of the patient. The amount of “matches” is based on the number of patients having similar parameters. Aside from typical drug therapy information, matches can indicate the adverse drug events and clinical outcomes for similar patients. The adverse drug events module 104 and the clinical outcomes module 106 described above enhance the patient data matching database of the archive database system submodule 306 to include adverse drug events and clinical outcomes. By reviewing the adverse drug events and clinical outcomes from matches, physicians are better informed in determining an appropriate course of drug therapy for their patients.

A variety of other databases may be used in connection with the medication management system 100. For example, the system 100 can provide a clinical trials database and related software for use in collecting and reporting data in connection with clinical trials. The system 100 can even be customized to a particular clinical trial. For example, customized databases can be developed for the following types of studies: phase IV efficacy and outcomes studies, complex prospective adverse drug event studies, pharmaeconomic analyses, drug use evaluation (DUE) studies, disease evaluation (DE) studies and epidemiological studies.

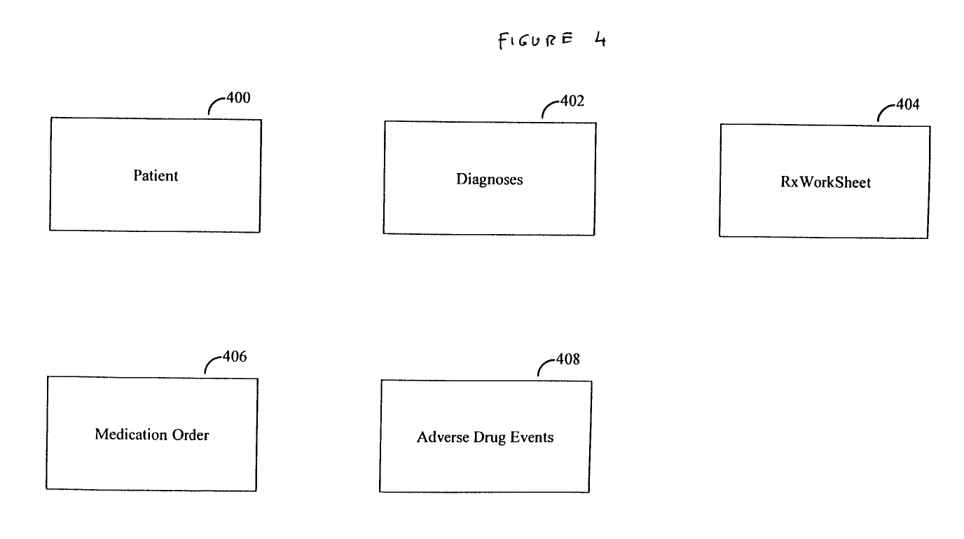

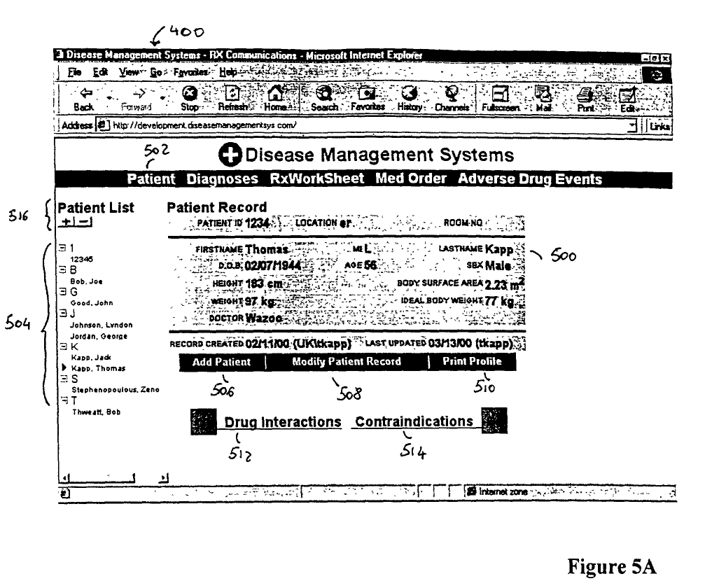

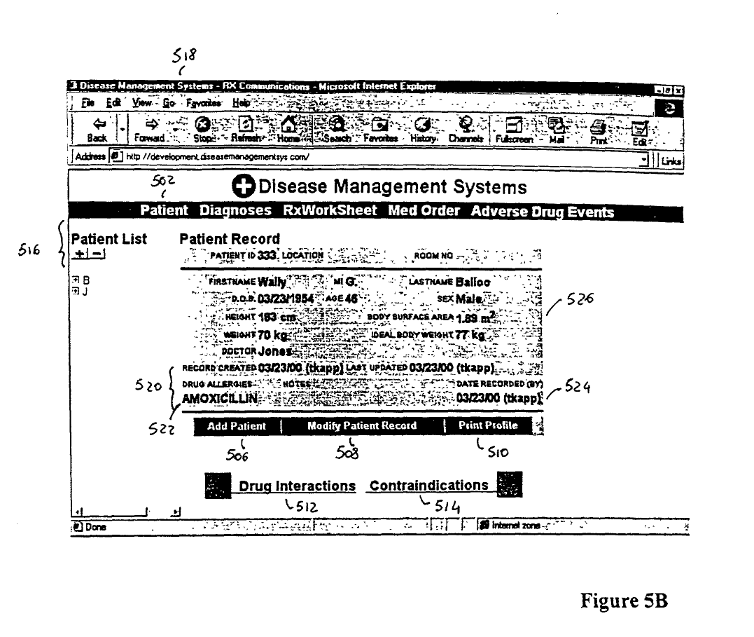

The medication management system 100 provides a comprehensive database which documents the drug use, diseases, clinical outcomes and adverse drug events for patients. More particularly, the medication management system 100 enables recording of pertinent patient data, drug dosing and dispensing, documenting and reporting of adverse drug events and tracking specific outcome data. Referring to FIG. 4, exemplary types of main web pages for the medication management system 100 are shown. These main web pages include a patient web page 400, a diagnoses web page 402, a RxWorkSheet web page 404, a medication order web page 406 and an adverse drug events web page 408. Exemplary screen shots for these web pages are described in connection with FIGS. 5A-22. Those skilled in the art are familiar with writing software to generate and control web pages. The patient web page 400 generally enables a physician to easily enter or read patient data. The diagnoses web page 402 generally enables a physician to easily enter or read diagnoses or medical conditions of patients. The RxWorkSheet web page 400 generally enables a physician to easily enter or read medications for patients. The medication order web page 406 generally enables a physician to generate or read on-screen medication orders for patients. Lastly, the adverse drug events page 400 generally enables the physician to record or report adverse drug events for patients. These main web pages for the medication management system 100 are illustrative and not exhaustive. Further, a number of related web pages may be associated with each illustrated main web page.

Referring to FIG. 5A, a patient web page 400 includes a patient record 500. The patient record 500 contains fields for various types of patient data including a patient identifier, location, room number, name, date of birth, age, sex, height, weight, body surface area, name of doctor and ideal body weight. These examples of patient data, some of which are entered and others of which are calculated, are only illustrative. For example, patient insurance data may also be included in the patient record 500. A variety of situations can arise where certain of these illustrated types of patient data are not needed or where additional patient data fields would be helpful. For example, in the context of clinical research, patient names need not be entered in order to maintain patient anonymity. The medication management system 100 thus accommodates research by physicians for drug companies. In a disclosed embodiment, the ideal body weight for a patient is continuously calculated.

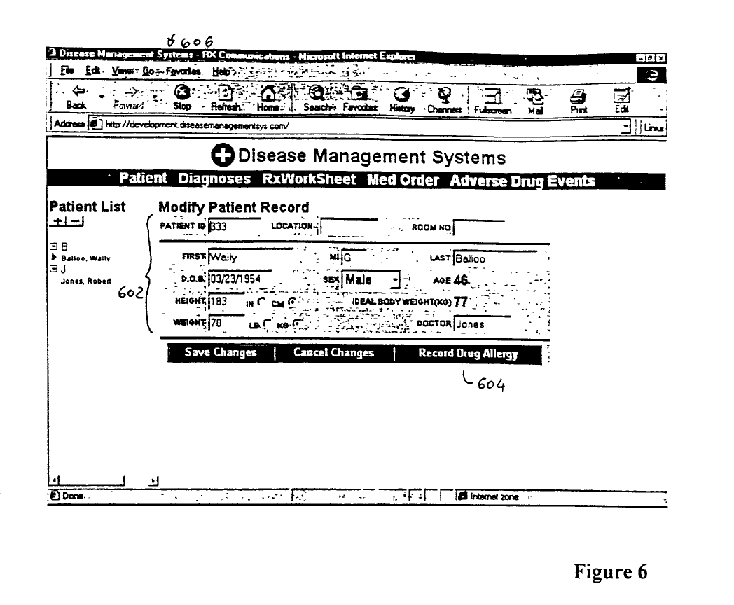

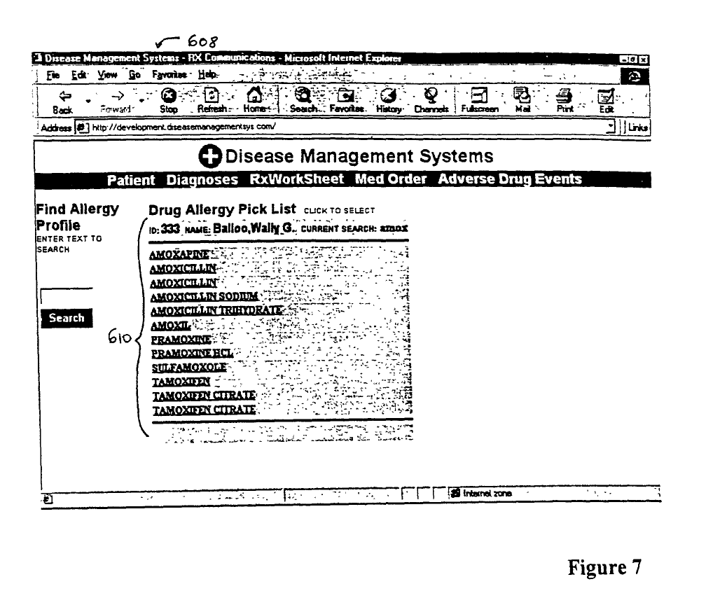

The web page 400 includes a variety of button links or hyperlinks related to the patient record 500. A button link 506 is provided on the web page 400 to go to a web page for adding a patient record. A patient record is entered per patient. A button link 508 is provided on the web page 400 to go to a web page for modifying the current patient record. A button link 510 is provided on the web page 400 to go to a web page for printing a patient profile. The patient profile is described below in connection with FIGS. 6 and 7. A text link 502 is provided on this and certain other web pages of the medication management system 100 to easily transition to the patient web page 400. A link is understood to be a way to move from one web page to another without entering a web address. In terms of directing the web browser 212 to a new web page, the web browser 212 may go to the new web page in the same window or may open a new window containing the new web page.

A text link 512 is provided on the web page 400 to go to a web page for performing drug interaction analysis for the patient. Similarly, a text link 514 is provided on the web page 400 to go to a web page to perform contraindication analysis for a patient. The text links 512 and 514 are preferably provided on certain web pages of the medication management system 100 for a physician to easily perform contraindication or drug interaction analysis for patients. In addition, if a new medication is added which presents a drug interaction problem, a red box containing the words “Drug Interaction” can pop up and remain until the medication is discontinued. The system 100 thus can be configured to perform drug interaction analysis and contraindication analysis whenever a new medication or medical condition is added. Use of contraindication or drug interaction analysis is described in U.S. patent application Ser. No. 09/032,512 entitled “Pharmacy Drug Management System Providing Patient Specific Drug Dosing, Drug Interaction Analysis, Order Generation and Patient Data Matching”, previously incorporated herein. If a new window is opened to perform contraindication or drug interaction analysis, then that window is closed after the physician clicks on an acknowledge button acknowledging the results. By performing contraindication and drug interaction analysis before a drug is prescribed, undue harm to a patient from selecting a drug that will adversely affect the patient is avoided. This also enables hospitals to avoid the costs associated with caring for patients experiencing adverse drug events while the hospitals are attempting to locate or contact the doctors.

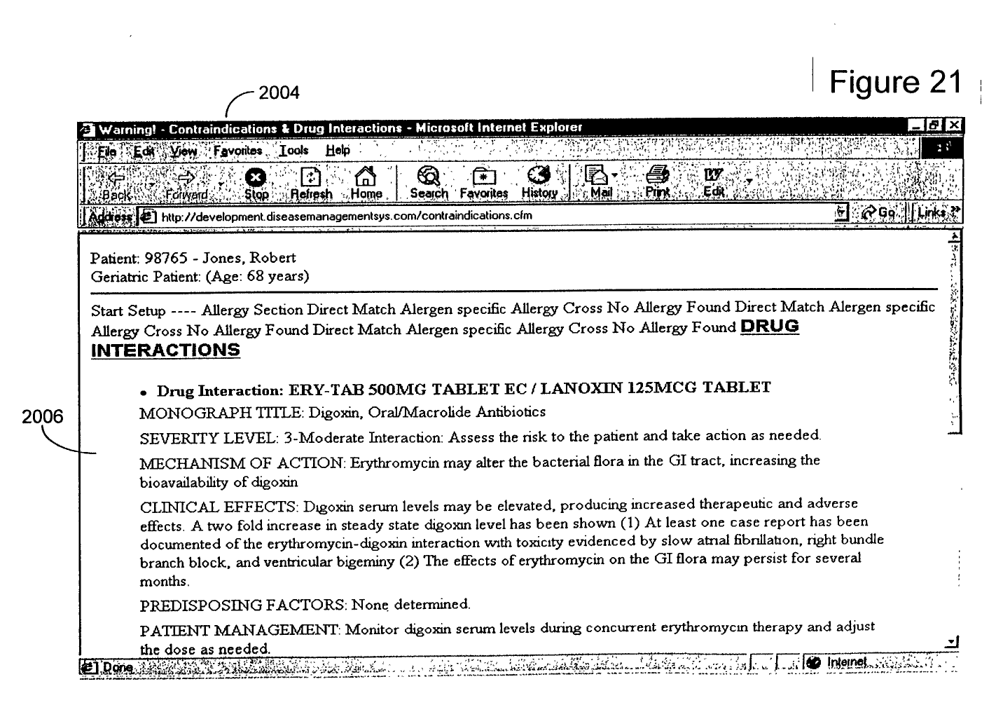

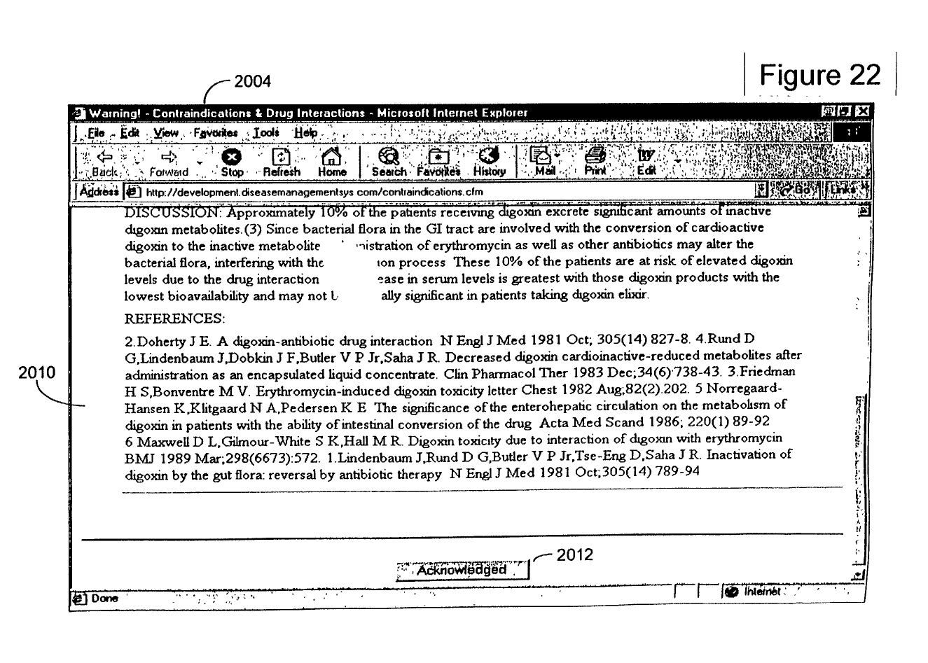

FIGS. 21 and 22 show an exemplary drug interaction web page 2004. The web page 2004 includes an upper analysis area 2006 (FIG. 21) and a lower analysis area 2010 (FIG. 22). These areas 2006 and 2010 provide information relevant to a drug interaction for the patient. In this case, the information pertains to a drug interaction between erythromycin and lanoxin, medications entered for the patient. More particularly, details are provided as to the nature, severity, management, and clinical effects of this drug interaction. Even medical references to obtain more detail about the drug interaction are shown in area 2010. An acknowledge button 2012 is shown in FIG. 22 for the physician to acknowledge his or her review of the drug interaction web page 2004.

Referring to FIG. 5A, a patient list 504 is provided on the web page 400 so that a physician can easily transition to a patient record for a different patient. Clicking on a text link in the form of the name of the patient such as shown transitions to a web page containing a patient record for that particular patient. Button links 516 are provided on the web page 400 to expand the patient list 504 to show all entered patients or to compress the patient list 504 to hide the text links for each entered patient.

Referring to FIG. 5B, a patient web page 518 includes a patient record 526. Unlike the patient web page 500 in FIG. 5A, the patient record 526 of the patent web page 518 includes a drug allergy section 520. This section 520 includes a drug allergy field 522 which stores the name of a drug allergy of the patient (in this case, amoxicillin) and a record date field 524 which records the date the drug allergy of the patient was entered into the medication management system 100. One advantage of recording the drug allergy of the patent in the medication management system 100 is that if a doctor attempts to add a drug for a patient which has been recorded as a drug allergy of the patent, then a drug allergy alert screen pops up immediately. Other aspects of the patient web page 518 are similar to the aspects of the patient web page 400 of FIG. 5A described above.

Referring to FIG. 6, an exemplary “Modify Patient Record” web page 606 shows a modify patient record area 602. Essentially any of the patient information entered into the patient record in connection with the patient web page 400 of FIG. 5A or the patient web page 518 of FIG. 5B can be modified here. This web page 606 can also be used to select to record a drug allergy as represented by a button link 604. Clicking on the “Record Drug Allergy” button link 604 sends the web browser 212 to a drug allergy web page 608 shown in FIG. 7. The web page 608 includes a drug allergy pick list 610 which contains text links for a comprehensive list of drugs. The relevant drug allergy can be selected by clicking on the text field or link in the pick list 610 for that drug. As shown by the record date field 524 in FIG. 5B the date the drug allergy is selected is recorded.

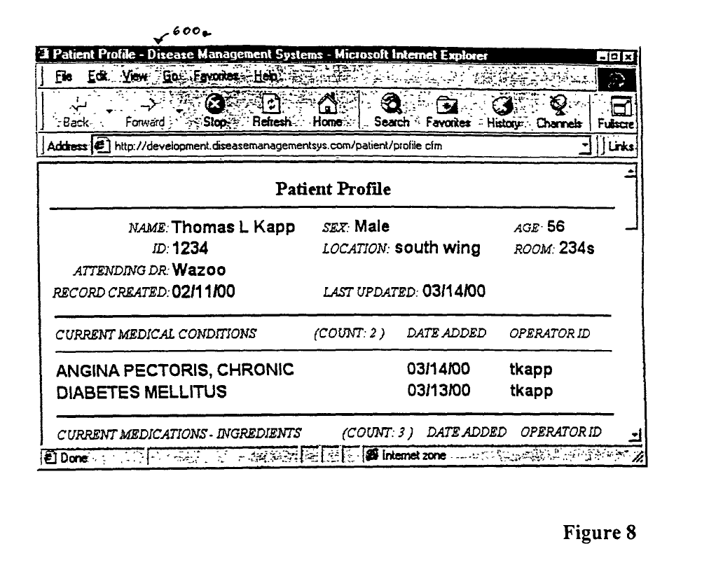

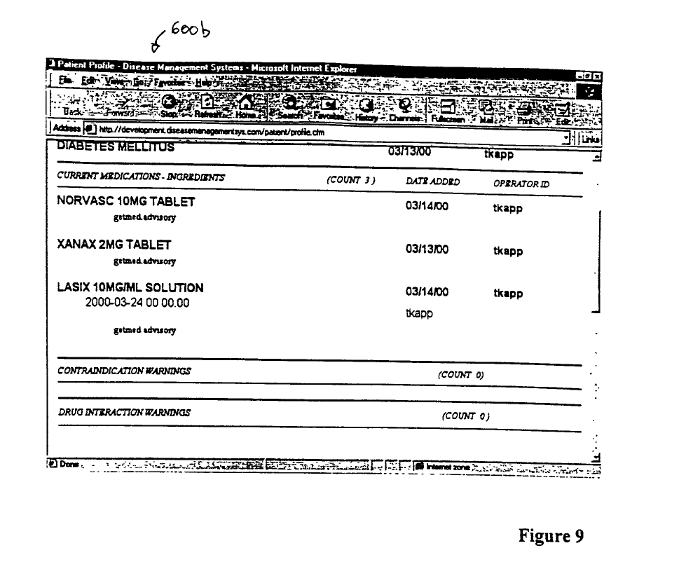

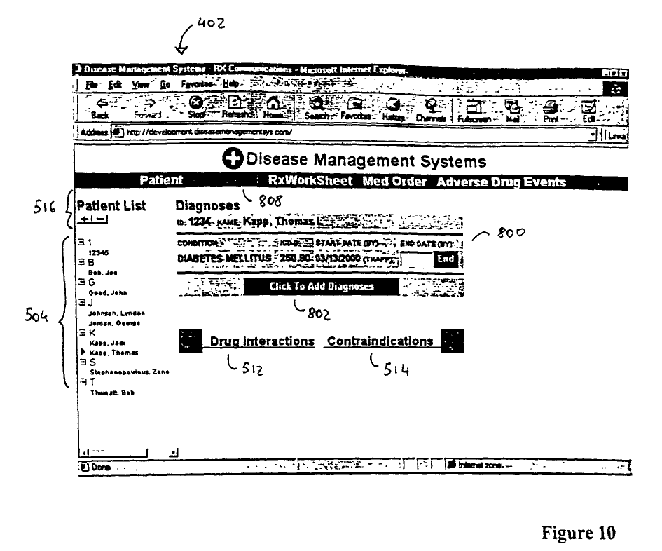

FIGS. 8 and 9 show a patient profile web page. Screen shot 600a of FIG. 6 represents a top portion of the web page, and screen shot 600b in FIG. 7 represents a bottom portion of the web page. A transition to this web page can be performed by clicking on the print profile link 510 on the patient web page 400 of FIG. 5A. In addition to the patient data from the patient record 500 in FIG. 5, the patient profile contains diagnoses data from the diagnoses web page 402 of FIG. 10 described below, medication data from the RxWorkSheet web page 404 described below (current and discontinued medications of the patient) and any contraindication or drug interaction warnings for the patient. Adverse drug events are also included in the patient profile. The one-page, on-screen patient profile is used by the physician in place of a physical patient file.

FIG. 10 shows the diagnoses web page 402 which can be accessed from another web page by clicking on the “diagnoses” text link 808. The web page 402 includes a diagnoses area 800 containing patient diagnoses or medical conditions, ICD-9 codes or class numbers for the medical conditions, start dates for the medical conditions, end dates for the medical conditions, a patient identifier and the patient name. Current and historical diagnoses of the patient are shown. These data fields in the diagnoses area 800 are illustrative only. This web page 402 basically enables a physician to readily determine the medical conditions for patients. A button link 802 is provided on the web page 402 for a physician to add a diagnosis for a patient.

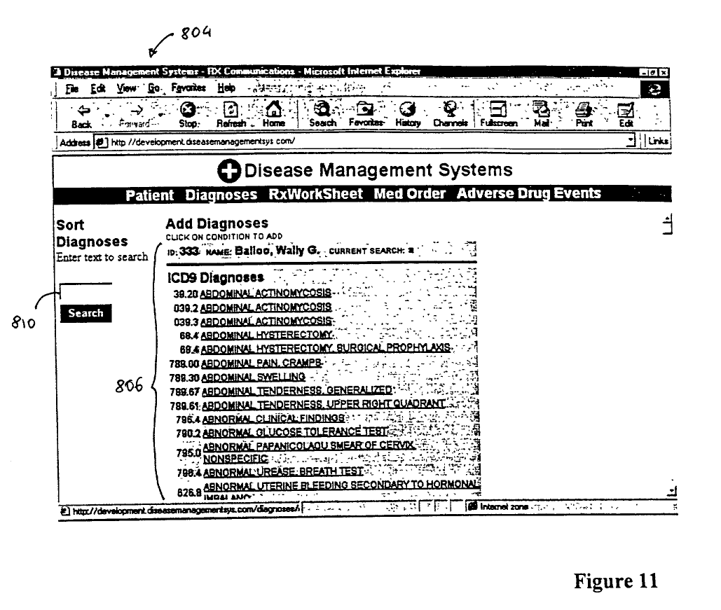

Referring to FIG. 11, an exemplary “Add Diagnoses” web page 804 is shown. This web page is accessed by clicking on the “Click to Add Diagnoses” button link 802 on the diagnoses web page 402 of FIG. 10. It should be understood that for certain computing systems such as a personal digital assistant, pointing rather than clicking is sufficient. A diagnoses selection area 806 is shown including each medical condition or diagnosis and its ICD9 class and subclass number. By clicking on the relevant diagnosis, the selected diagnosis is added to the diagnoses area 800 shown in FIG. 10. A search area 810 is provided on the web page 804 so a physician can enter an ICD9 number or a first few letters of a diagnosis to advance the diagnoses selection area 806 to the corresponding diagnosis.

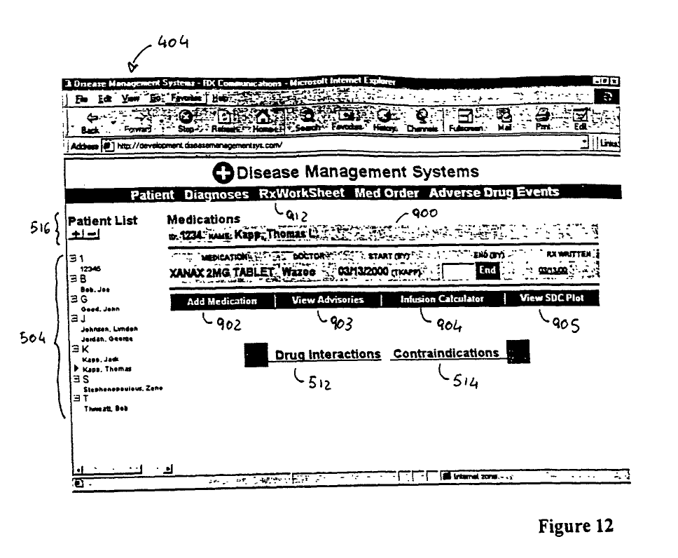

FIG. 12 shows the RxWorkSheet web page 404 (accessible from another web page by clicking on a text link 912) which includes a medications area 900 providing medication information for a patient. In this example, the medications area 900 includes data fields for the name of a medication, the name of the doctor for the patient, the start date of the medication, the end date of the medication, the date the on-screen medication order was written, the patient identifier and the patient name. All medications of the patient are shown on the medications area 900. These data fields are illustrative only, as data fields can be easily added or deleted from the medications area 900 if appropriate. If a patient is being seen by multiple physicians, each physician can readily access the complete medication history for the patient. The use of a start date and end date for a medication enables a physician to readily determine both the past and current medications for a patient.

A text link 902 transitions to a web page for adding a medication to the medications area 900. Since drugs can be added but not deleted, the medication management system 100 maintains a permanent record of the medication history of a patient. A text link 903 transitions to a web page for viewing a formulary of medications. The formulary can be configured to include a list of available medications approved by a third-party payer (e.g., an HMO) for the particular physician. A physician can set up different formularies for each third-party provider of the physician. A link can be provided on a web page to the formulary of each third-party payer. By using a formulary of medications approved by a third-party payer, a physician can avoid prescribing a medication which the third-party payer has not approved. The system 100 can even provide alternative medication selections to a selected drug if the selected drug is not in an approved formulary of a third-party payer. If a physician wishes to prescribe a medication which is not in the approved formulary of a third-party payer, then the physician can click on a button to request approval of that medication from the third-party payer. The medication management system 100 can alert the physician of the response of the third-party payer to the request of the physician.

A text link 904 transitions to a web page for using an infusion or kinetic dosing calculator to determine the proper dosing of certain medications. For drugs that require mixing, the infusion calculation calculates the bag size and infusion rate for single or multiple drugs. A bag label is then produced based on these calculations. A text link 905 transitions to a web page for viewing an SDC (serum drug concentration) plot. The SDC plot can be used in connection with calculating and adjusting the dosing of a drug. Use of an infusion calculator and SDC plots is described in U.S. patent application Ser. No. 09/032,512 entitled “Pharmacy Drug Management System Providing Patient Specific Drug Dosing, Drug Interaction Analysis, Order Generation And Patient Data Matching” previously incorporated herein.

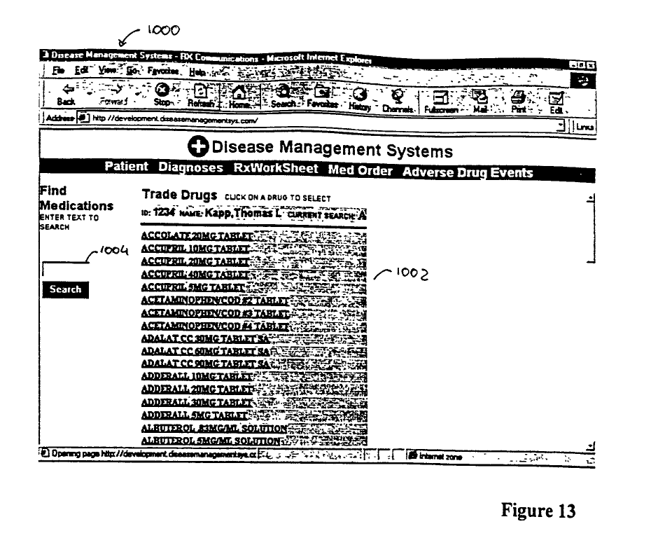

FIG. 13 shows an exemplary formulary web page 1000. A formulary area 1002 on the web page 1000 includes a list of medications. The list can include the trade names and generic names for medications. To jump directly to a desired medication, a physician enters the first few letters for the medication in a search area 1004 on the web page 1000. A medication is selected by clicking on a text field in the list for the medication. When a medication is selected, an advisory for that medication can automatically be provided on a web page. The advisory can be specific to the medication, specific to the disease or medical condition or specific to the class of patient (neonatal, pediatric or geriatric). An advisory can also provided of suggested or recommended drug therapies of medical societies. For example, by clicking on a therapy recommendation assistant link, a new web page can show endorsed guidelines or suggested drug therapies for a particular medication. These guidelines and therapies are of course continually updated as they are developed and endorsed.

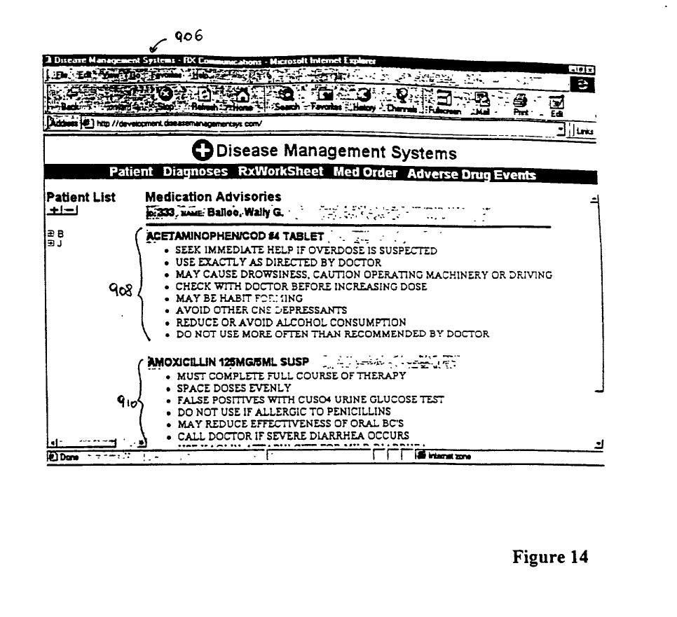

Referring to FIG. 14, a “Medication Advisories” web page 906 is shown. As mentioned, the medication management system 100 is configured such that this web page automatically pops up when a medication is selected for a patient. For this example, the web page 906 includes an advisory area 908 containing an advisory for acetaminophen and an advisory area 910 containing an advisory for amoxicillin. In a lower portion of the web page 906 which could be seen by scrolling down, an acknowledge button is presented for the physician to acknowledge viewing of the advisory. Once acknowledged, the web browser 212 returns to the RxWorkSheet web page 404 shown in FIG. 12.

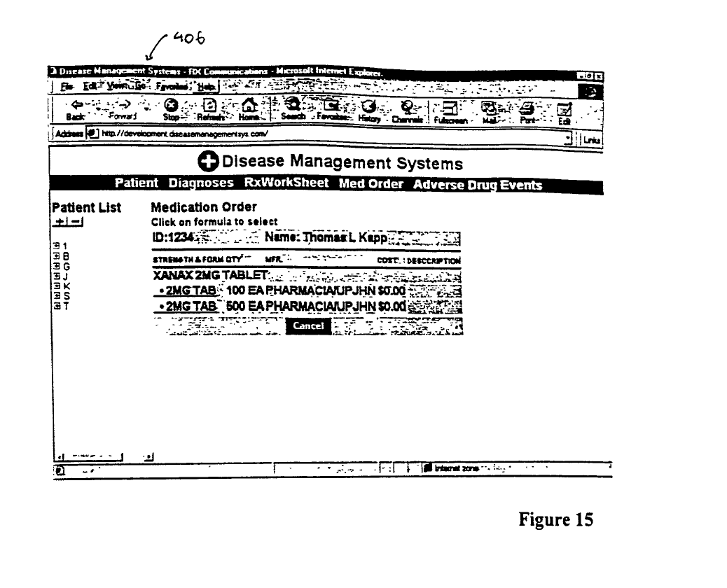

FIG. 15 shows a web page 406 including a medication strength/form selection area 1100. The area 1100 contains data fields for the strength and forms of the medication, the possible quantities of the medication, the manufacturer of the medication, the wholesale cost of the medication, the description of the medication, the patient identifier and the patient name. This web page 406 is generated after selection of a medication. The medication management system 100 is configured with or aware of each possible strength, form and quantity of each medication. The system 100 is also aware of the manufacturer and cost of each medication. The web page 406 easily enables a physician to select an appropriate strength and form for the selected drug to be placed in the medication order. A cancel button 1102 is provided on the web page 406 to enable the physician to cancel the medication order if appropriate.

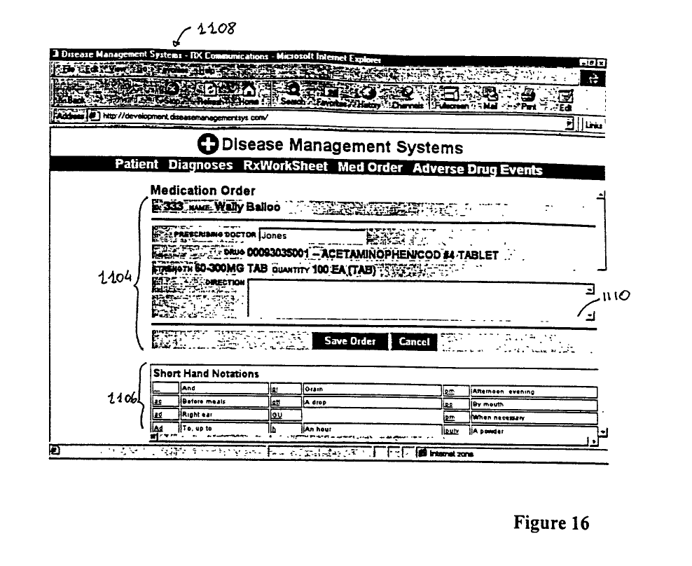

Referring to FIG. 16, a medication order web page 1108 including an on-screen medication order 1104 is shown. The on-screen medication order 1104 contains data fields for the patient identifier, the patient name, the name of the prescribing doctor, the name of the drug, the strength and form of the drug, the quantity of the drug and the directions. With respect to the directions, a direction area I 100 is shown for containing short hand notations for the directions for the patent to follow in taking the medication. The web page 1108 includes a short hand notations area 1106 containing a list of the various short hand notations for directions for taking medications. By clicking on a short hand notation in the area 1106, that short hand notation is placed into the direction area 1110. Each applicable short notation is clicked on by the physician to provide the appropriate direction for the on-screen medication order 1104. This web page 1108 and other web pages related to the preparation of the on-screen medication order 1104 easily enable a physician to generate or prepare a medication order (or prescription) for a patient without physically writing an order. The on-screen medication order 1104 can be printed, faxed or electronically transmitted. The format of the printed order can be customized to comply with state requirements. The medication management system 100 can be configured to validate or require a physician to acknowledge certain actions related to the processing of the on-screen medication order 1104.

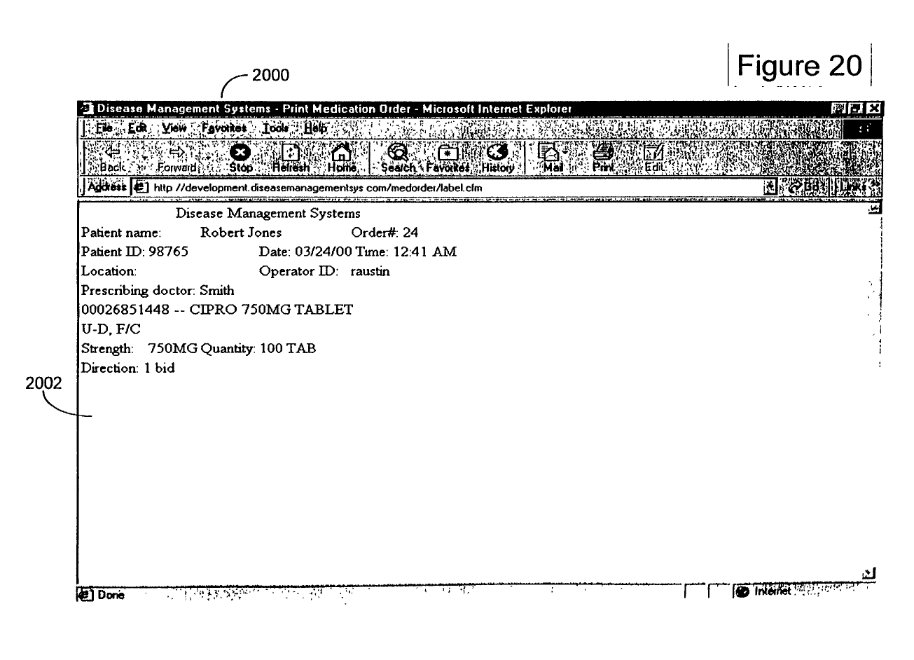

FIG. 20 shows a label web page 2000 with information from an on-screen medication order. A label area 2000 includes the data required for a prescription. In this case, the area 2000 includes the patient name, order number, patient identifier, date of prescription, time of prescription, patient location, operator identifier, prescribing doctor, medication code and name, medication strength, medication quantity and the direction for the medication. This web page 2000 reflects the information that will be included on a label with the medication.

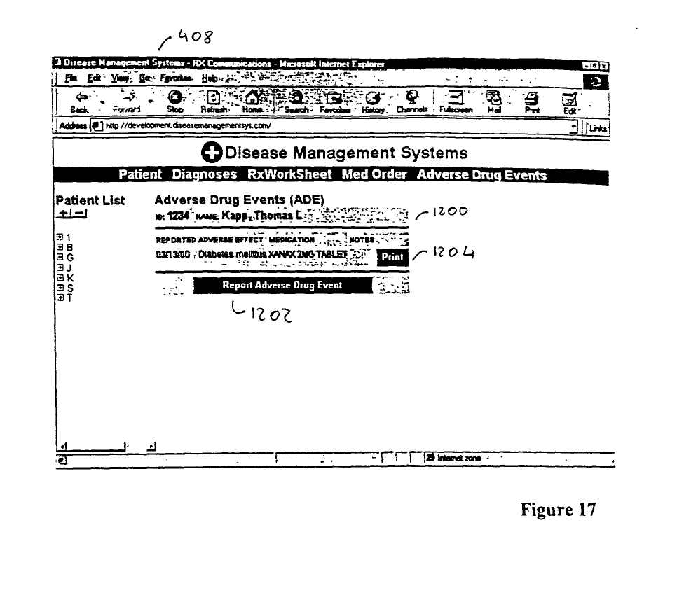

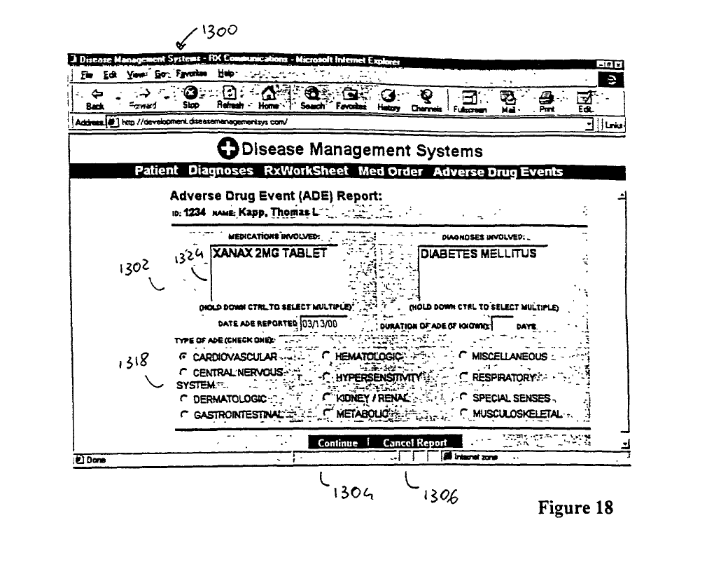

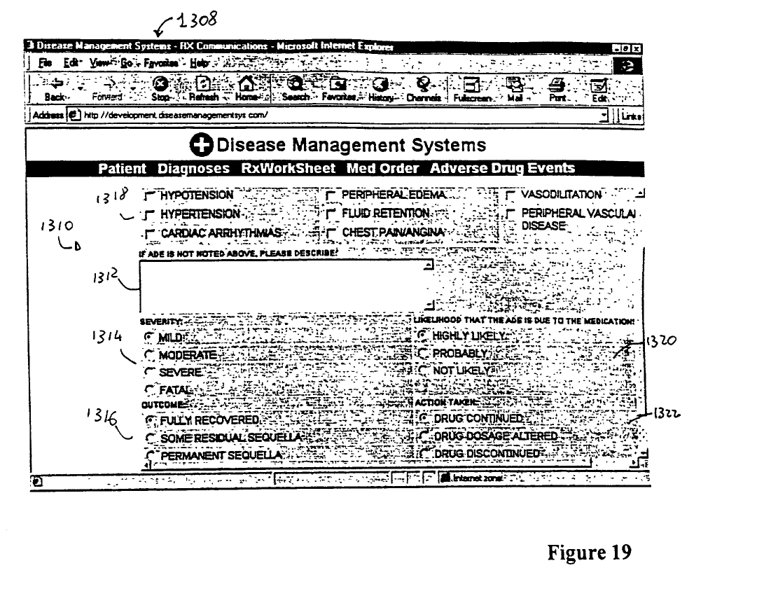

FIG. 17 shows an adverse drug events (ADE) web page 408 including an adverse drug events area 1200. The area 1200 includes data fields for the report date of an adverse drug event, the type of the adverse drug event, the medication which caused the adverse drug event, any notes regarding the adverse drug event, the patient identifier and the patient name. In this way, a physician can easily view any adverse drug events reported for a patient. This web page 408 provides a report button 1202 for a physician to report an adverse drug event. Selecting the report button 1202 sends the web browser 212 to the adverse drug event report web page 1300 shown in FIG. 18. The web page 1300 includes an adverse drug event report area 1302 containing data fields for information useful for reporting an adverse drug event. In this example, the area 1302 stores the name of the medication involved, the diagnoses involved, the date the adverse drug event is being reported, the duration of the adverse drug event, and the type of the adverse drug event. Additional data fields for other information relevant to an adverse drug event may also be included in the adverse drug event report area 1302 as described in connection with FIG. 19. Since the medication management system 100 is already aware of the medications and diagnoses of a patient through the diagnoses web page 402 and the RxWorkSheet web page 404, the physician does not need to re-enter such information for the adverse drug event report web page 1300. Instead, the physician clicks on the relevant medication to select that medication for the particular adverse drug event report. Similarly, the physician clicks on a relevant diagnosis to select for the adverse drug event report.

An area 1324 includes a list of each medication of the patient, and the area 1326 includes a list of each diagnosis of the patient. The physician also does not need to enter the type of adverse drug event in the report area 1302 since the area 1302 contains a comprehensive list of different types of adverse drug events. Any of the adverse drug events in the list can be selected by the physician by clicking on or pointing to the relevant adverse drug event, depending upon the type of computing system used by the physician to access the medication management system 100. If the relevant adverse drug event is not in the list, an adverse drug event can be entered on the web page as described in connection with FIG. 19. text button 1306 enables a physician to cancel the adverse drug event report if appropriate, variety of other links related to adverse drug events can be used. For example, a link can be provided to generate a quarterly summary report of adverse drug event reports by drug type or type of adverse drug event.

A text button 1304 enables a physician to continue entry of information for the adverse drug event report on an adverse drug event report web page 1308 shown in FIG. 19. More particularly, the web page 1308 includes a general category area 1318 for selecting an adverse drug event (also shown in FIG. 18) and an area 1312 for a physician to enter the relevant adverse drug event if the adverse drug event is not contained in the area 1318. The web page 1308 further includes a severity area 1314 to select the severity of the adverse drug event (choices include mild, moderate, severe and fatal), an outcome area 1316 to select the outcome resulting from the adverse drug event (choices include fully recovered, some residual sequela and permanent sequela), a probability area 1320 to select the likelihood that the adverse drug event is due to the medication (choices include highly likely, probably and not likely), and an action taken area 1322 to select the action taken by the physician with respect to the drug (choices includes drug continued, drug dosage altered and drug discontinued). These types of adverse drug event information described and shown are illustrative and not exhaustive. A separate adverse drug event report is prepared for each adverse drug event. Therefore, if a single drug causes multiple adverse drug events, a different adverse drug event report is recorded for each related adverse drug event. The reporting of adverse drug events using the medical management system 100 enables drug companies to more readily learn of adverse drug events. In this way, a drug company can discover the adverse effects of a medication before millions of dollars are expended in selling or marketing the medication.

The medication management system 100 also enables a physician to document quality of practice and to benchmark performance data. It should be understood that the medication management system 100 can generate both clinical and economic data. For example, the system 100 can generate economic data which compares the economic impact between various drug therapies. As another example, the system 100 can track weight loss and adverse drug events associated with various weight loss therapies. It should further be understood that aside from adverse drug events, desirable drug outcomes can also be recorded by the system 100. Adverse or desirable outcomes associated with a given patient population, medication or disease can be generated and tracked by the system 100.

If desired, sound to provide audio feedback or cues to physicians can be enabled for any of the illustrated web pages. Also, any web page of the medical management system 100 can be enhanced to provide links for a physician to directly order x-rays or laboratory tests for a patient. In addition, all of the clinical and economic data in the medication management system 100 can be exported to other systems such as the billing system of the physician for example. In this way, time and costs from duplicating or re-entering data into other systems can be avoided.

Thus, a web-based medication management system, which resides on a secure web site of a private network, is utilized by physicians in the global medical/pharmacy community to manage drug therapy for patients. The system is a comprehensive drug management system that creates an Internet-based environment for recording, documenting and summarizing real time data regarding drug prescribing and dispensing activities. Physicians can conveniently access the medication management system software over the Internet from essentially anywhere in the world using a computer system or other computing system with modem and web browsing capabilities. The system easily enables physicians to enter or read patient profile data, patient diagnoses, patient medications, clinical outcomes and adverse drug events. As well, physicians can generate, read or electronically transmit on-screen medication orders for patients. The system also enables physicians to access a searchable patient data matching database of drug therapy data (including clinical outcomes and adverse drug events) for patients with similar diseases for use in managing the drug therapy of their patients. The medication management system not only provides for simple and fast extraction of outcome-specific data but also simplifies medication dispensing and documentation. The system also organizes and enables retrieval of outcome data resulting from drug prescribing practices. With the medication management system 100, physicians can better manage the care of medications and diseases of patients and spend significantly less time with paperwork and phone calls for patients.

The foregoing disclosure and description of various embodiments are illustrative and explanatory thereof, and various changes in the modules, web pages, links, order of steps, data fields, and code elements, as well as in the details of the illustrated hardware and software and construction and method of operation may be made without departing from the spirit of the invention. Based on the foregoing disclosure, one skilled in the art would know how to program a computer or other computing system to perform the steps described herein.

What is claimed is:

1. A method for operating a drug database system, said method comprising the steps of:
(a) providing a database of drug information;
(b) facilitating selective access to said database by a first user via communication links;
(c) receiving information from said at least one first user upon access; and
(d) supplying drug output information in response to said received information.

2. The method according to claim 1, wherein said step of supplying drug output information supplies said information to said first user.

3. The method according to claim 1, wherein said first user is in a group including other users and said step of supplying drug output information supplies said information to one other user in said group that is associated with said first user.

4. The method according to claim 1, wherein said facilitating, receiving and supplying steps are performed in real time.

5. The method according to claim 1, wherein said first user is a physician.

6. The method according to claim 1, wherein said first user is a pharmacist.

7. The method according to claim 1, wherein said first user is a nurse.

8. The method according to claim 1, wherein said first user is a patient.

9. The method according to claim 1, further comprising the step of facilitating selective access to said database by a second user, said selective access permitting said second user to modify the drug information stored in said database.

10. The method according to claim 9, wherein said step of facilitating selective access to said database by a second user is done in real time.

11. The method according to claim 9, wherein said second user is a drug manufacturer.

12. The method according to claim 9, wherein said second user is a drug researcher.

13. The method according to claim 1, wherein said received information includes a drug name.

14. The method according to claim 1, wherein said received information includes a name of a medical malady.

15. The method according to claim 1, wherein said received information includes information about certain drugs and the output information includes information about adverse side effects of taking said certain drugs.

16. A method for providing patient specific drug, dosing, drug interaction analysis and order generation comprising the steps of:
(a) providing a drug management program executed by a computer system;
(b) providing a plurality of communicating links for connecting users via a communication device to said system;
(c) accessing said drug management program by a first user to enter adverse drug affects information; and
(d) accessing said drug management program by a second user to enter patient drug dosing information;
wherein said first and second accessing steps are order independent.

17. The method according to claim 16, further including the step of interacting said first user with said second user in real time to update drug information on said drug management program wherein said first user is a pharmacist and said second user is a physician.

18. The method according to claim 16, further including the step of interacting said first user with said second user in real time to update drug information on said drug management program wherein said first user is a drug company and said second user is a physician.

19. The method according to claim 16, further including the step of requesting adverse drug information on said drug management program by said first user with said second user in real time wherein said first user is a pharmacist and said second user is a drug company.

20. The method according to claim 16, further including the step of accessing a patient data matching database for matching patients to specific drug therapies of other patients in the same disease or medical condition class.

21. The method according to claim 20, further including the step of interacting multiple users in real time to generate patient matching.

22. The method according to claim 16, further including a step of interacting in real time multiple users to update patient or drug information.

23. The method according to claim 16, further including a step of linking a formulary of medications approved by a third-party payer to a physician.

24. The method according to claim 23, said linking step further includes interacting said physician in real time with said third-party payer wherein said physician can request approval of payment for medication.

25. The method according to claim 16, further including a step of accessing said drug management program for drug information on a medication wherein said user selects a drug and said a drug management program provides said user with an advisory guideline and therapies for said drug.

26. The method according to claim 25, further including a step of continually updating guidelines and therapies for said drug.

27. The method according to claim 16, further including the step of effecting physician requested drug order in real time to a pharmacist.

28. The method according to claim 16, further including a step of linking a physician to a healthcare unit wherein said physician orders x-rays or laboratory tests for a patient.

29. The method according to claim 16, wherein the communication device communications through an electronic communication network

30. The method according to claim 16, wherein the electronic communication network is selected from the group consisting of the internet, telephone, satellite, cellular switch, cable, computer, optical or wireless.

31. The method according to claim 16, wherein the electronic communication network is a telephone communication network.

32. The method according to claim 16, wherein the telephonic communication device is a touch tone phone.

33. The method according to claim 16, wherein the telephonic communication device is a videophone.

34. A method according to claim 16, wherein the electronic communication device includes a wireless short message service message, and the wireless short message service is configured to respond to receipt of medical data for a patient by forwarding a message to a wireless receiver corresponding to the medical data for a patient.

35. The method according to claim 16, further includes step of checking drug dosage.

36. A pharmaceutical drug management care system for providing a patient specific drug, dosing, drug interaction analysis and order generation said system comprising:
(a) at least one communication device;
(b) at least one communication link; and
(c) a computer having a processor, a database and adapted by patient drug dosing software to include:
(i) at least one data entry engine;
(ii) an order generator;
(iii) a kinetic drug doser; and
(iv) a database retrieval and recording engine.

37. The system according to claim 36, further including a therapy coordination engine.

38. The system according to claim 36, further including a means of updating the system with a back up remoter version of web-based medication management system when the internet is down wherein said system is updated with information from the local version of the medication management system on the computer.

39. The system according to claim 36, further comprising:
(a) a drug management program executed by a computer system;
(b) a plurality of communicating links for connecting users via a communication device to said system;
(c) a means for accessing said drug management program by a first user to enter adverse drug affects information; and
(d) a means for accessing said drug management program by a second user to enter patient drug dosing information;
wherein said first and second accessing steps are order independent.

40. The system according to claim 36, further comprising a means for interacting multiple users in real time to update drug information.

41. The system according to claim 36, further comprising a means for requesting adverse drug information by multiple users.

42. The system according to claim 36, further comprises a server processor wherein said processor is a gateway function that provides the users access to an environment.

43. The system according to claim 42, wherein the gateway function is a Web server.

44. The system according to claim 42, wherein the users consist of physicians, pharmacists, patients, healthcare provider or drug companies.

45. The system according to claim 42, wherein said environment is a distributed file system service, web-based, cable, or wireless.

46. The system according to claim 42, wherein said environment uses software or hardware for maintaining a virtual network.

47. The system according to claim 36, further comprising a means for accessing a patient data matching database for matching patients to specific drug therapies of other patients in the same disease or medical condition class.

48. The system according to claim 36, further comprising a means for linking a formulary of medications approved by a third-party payer to a physician.

49. The system according to claim 48, further comprising a means for said physician to interact in real time with said third-party payer wherein said physician can request approval of payment for medication.

50. The system according to claim 36, further comprising a means for accessing said pharmaceutical drug management care system for drug information on a medication wherein said user selects a drug and said pharmaceutical drug management care system provides said user with an advisory guideline and therapies for said drug.

51. The system according to claim 36, further comprising a means for continually updating guidelines and therapies for said drug.

52. The system according to claim 36, further comprising a means for effecting physician requested drug order in real time to a pharmacist.

53. The system according to claim 36, further comprising a means for providing links for a physician to order x-rays or laboratory tests for a patient.
